(19) United States
(12) Patent Application Publication
(10) Pub. No.: US 2026/0135379 A1
(43) Pub. Date: May 14, 2026

(54) POWER SUPPLY SYSTEM AND SWITCHING CIRCUIT

(71) Applicant: SoftBank Corp., Tokyo (JP)

(72) Inventors: Takashi Hirakawa, Tokyo (JP); Naoki Hasegawa, Tokyo (JP); Yuta Nakamoto, Tokyo (JP); Yoshichika Ota, Tokyo (JP)

(73) Assignee: SoftBank Corp., Tokyo (JP)

(21) Appl. No.: 19/476,733

(22) PCT Filed: Mar. 13, 2024
(86) PCT No.: PCT/JP2024/009760

§ 371 Date: Oct. 20, 2025

(30) Foreign Application Priority Data
Apr. 25, 2023 (JP) 2023-071551

(51) Int. Cl. H02J 1/12; H02J 50/00; H02J 50/20; H02J 101/24

(52) U.S. Cl. CPC H02J 1/12; H02J 50/001; H02J 50/20; H02J 2101/25

(57) ABSTRACT

Provided is a power supply system that can increase a power supplied by a whole of the system that supplies a power to a target apparatus. The power supply system comprises a plurality of DC power sources including an environmental-power-generation apparatus and a power-reception apparatus for wireless power transfer, and a switching circuit. The switching circuit has a plurality of input sections to which the plurality of the DC power sources are connected, and a plurality of output sections that output DC powers to a plurality of power-supply targets, and switches connection states between the plurality of the input sections and the plurality of the output sections. One or plural power-reception apparatuses for wireless power transfer and one or plural environmental-power-generation apparatuses may be included. The plurality of the DC power sources may include one or plural photovoltaic-power-generation apparatuses. The environmental-power-generation apparatus may be at least one of a thermal-power generation apparatus, a vibration-power generation apparatus and a radio-wave power generation apparatus.

### TECHNICAL FIELD

The present invention relates to a power supply system including a power-reception apparatus for wireless power transfer and a switching circuit that can be used in the power supply system.

### BACKGROUND ART

As a terminal apparatus that connects to and communicates with a communication relay apparatus such as a base station or a wireless LAN access point apparatus in a conventional communication system, there is a portable-type terminal apparatus that mainly uses a power supplied from a built-in battery. In this terminal apparatus, a cumbersome task of charging the built-in battery is required when a remaining charge amount in the built-in battery becomes low. Furthermore, a terminal apparatus that uses an electric power supplied from a wired connected power line rather than from the built-in battery is limited to use in locations where such a power line is available. Thus, a power supply infrastructure capable of supplying electric power to various terminal apparatuses that connect to and communicate with a communication relay apparatus such as a base station has not yet been developed.

In particular, in the fifth generation and subsequent next-generation communication systems, the number of terminal apparatuses (for example, user apparatuses, IoT devices, etc.) that connect to and communicate with a communication relay apparatus such as a base station and a wireless LAN access point apparatus is expected to increase rapidly, and a development of communication infrastructure to handle the huge amount of traffic is underway. However, a power supply infrastructure capable of supplying electric power to the enormous number of terminal apparatuses that perform the foregoing communications remains underdeveloped. Furthermore, a power supply infrastructure capable of supplying power to a large number of IoT devices such as sensors without the foregoing communication function also remains underdeveloped.

There is conventionally known an environmental-power-generation apparatus that can generate an electrical power by harvesting a minute amount of energy from an environment and supply the power to a power-supply target such as a sensor. For example, the cited literature 1 discloses an environmental-power-generation apparatus that is provided with a radio-wave power generation apparatus that receives AM radio waves, FM radio waves, TV radio waves and wireless LAN radio waves and generates electricity from the received radio waves, a vibration-power generation apparatus that has a vibration-electricity conversion element that vibrates when subjected to an external force and generates electricity using the vibration of the vibration-electricity conversion element, and a thermoelectric-power generation apparatus that has a thermoelectric element section and generates electricity using the thermoelectric force generated in the thermoelectric element section.

### CITATION LIST

### Patent Literature

Patent Literature 1: Japanese Unexamined Patent Application Publication No. 2012-244846.

### SUMMARY OF INVENTION

### Technical Problem

Although the environmental-power-generation apparatus can harvest a minute amount of energy from an environment and supply the generated power, there is a problem that the power capable of being supplied to power-supply targets such as terminal apparatuses and sensors is insufficient using only the environmental-power-generation apparatus.

### Solution to Problem

A power supply system according to an aspect of the present invention comprises a plurality of DC power sources including an environmental-power-generation apparatus and a power-reception apparatus capable of receiving a beam for wireless power transfer and outputting a DC power, and a switching circuit that has a plurality of input sections to which the plurality of the DC power sources are connected and a plurality of output sections that output DC powers to a plurality of power-supply targets, and that switches connection states between the plurality of the input sections and the plurality of the output sections.

In the foregoing power supply system, the plurality of the DC power sources may include one or plural power-reception apparatuses for wireless power transfer, one or plural photovoltaic-power-generation apparatuses, and one or plural environmental-power-generation apparatuses.

In the foregoing power supply system, the environmental-power-generation apparatus may be at least one of a thermal-power generation apparatus, a vibration-power generation apparatus, and a radio-wave power generation apparatus.

In the foregoing power supply system, the power supply system may comprise a first control section for controlling a switching of connection states between the plurality of the input sections and the plurality of the output sections in the switching circuit. Herein, the first control section may receive control information from an external apparatus such as a server, a management apparatus, or a center apparatus, and control switching of connection states between the plurality of the input sections and the plurality of the output sections in the switching circuit based on the control information.

In the foregoing power supply system, the power supply system may comprise a plurality of DC control circuits that are connected to the plurality of the output sections of the switching circuit. Herein, the DC control circuit may have at least one circuit of an MPPT (Maximum Power Point Tracking) control circuit, a DC-DC conversion circuit, and a rectification circuit. Further, the power supply system may comprise a second control section for controlling the DC control circuit. The second control section may receive control information from an external apparatus such as a server, a management apparatus or a center apparatus, and control the DC control circuit based on the control information.

In the foregoing power supply system, the power supply system may comprise a system battery for supplying a DC power to the switching circuit, the plurality of the output circuits, or both, and the plurality of the output sections of the switching circuit may include an output section for outputting a DC current to the system battery.

A switching circuit according to another aspect of the present invention comprises a plurality of input sections to which a plurality of DC power sources are connected, and a plurality of output sections that output DC powers to a plurality of power-supply targets, and the switching circuit switches connection states between the plurality of the input sections and the plurality of the output sections.

In the foregoing switching circuit, the switching circuit may comprise a plurality of plus-input sections to which plus-output terminals of the plurality of the DC power sources are connected, a plurality of minus-input sections to which minus-output terminals of the plurality of the DC power sources are connected, a plurality of plus-output sections, a plurality of minus-output sections, and a connection circuit section provided between the plurality of the plus-input sections and the plurality of the minus-input sections, and the plurality of the plus-output sections and the plurality of the minus-output sections, and has a plurality of switches capable of respectively controlling a turn on/off so as to switch connection states between the plurality of the DC power sources and the plurality of the plus-output sections and the plurality of the minus-output sections.

In the foregoing switching circuit, the connection circuit section may include a plurality of first connection lines that are individually connected to the plus-output terminals of the plurality of the DC power sources, a plurality of second connection lines that are individually connected to the minus-output terminals of the plurality of the DC power sources, a plurality of first switches capable of respectively controlling a turn on/off that are individually disposed between the plurality of the first connection lines and the plurality of the plus-output sections, a plurality of second switches capable of respectively controlling a turn on/off that are individually disposed between the plurality of the second connection lines and the plurality of the minus-output sections, and a plurality of third switches capable of respectively controlling a turn on/off which are disposed between the first connection lines and the second connection lines of combinations in which the DC power sources are different from each other, among plural combinations of the plurality of the first connection lines and the plurality of the second connection lines.

In the foregoing power supply system provided with the switching circuit, the first switch and the second switch may be controlled to be on, and the third switch may be controlled to be off.

In the foregoing power supply system provided with the switching circuit, each of the number of the plurality of the DC power sources, the number of the plurality of the first connection lines, the number of the plurality of the connection lines, the number of the plurality of the first switches and the number of the plurality of the second switches may be N, the number of the plurality of the third switches may be N²−N, a first of the first switches, which is disposed on a first of the first connection lines individually connected to a plus-output terminal of a first DC power source, may be controlled to be on, an N-th of the second switches, which is disposed on an N-th of the second connection lines individually connected to a minus-output terminal of an N-th DC power source, may be controlled to be on, a third switch, which is disposed between an n-th of the first connection lines individually connected to a plus-output terminal of an n-th (n=2 to N) DC power source and an n−1-th of the second connection lines individually connected to a minus-output terminal of an n−1-th DC power source, may be controlled to be on, and the other switches of the first switches, the second switches and the third switches may be controlled to be off.

In the foregoing power supply system provided with the switching circuit, when the number of the plurality of the DC power sources is N, the total number of the plurality of the switches is N²+N, and an on state is represented as 1 and an off state is represented as 0, the second control section may control the on/off of the plurality of the switches based on the following matrix with (N+1) rows and (N+1) columns.

$$[ \begin{matrix}0 & 1 or 0 & … & 1 or 0 \\ 1 or 0 & ⋱ & ⋱ & ⋮ \\ ⋮ & ⋱ & ⋱ & 1 or 0 \\ 1 or 0 & … & 1 or 0 & 0\end{matrix} ] \qquad [ Mathematical 1 ]$$

In the foregoing power supply system provided with the switching circuit, the power supply system may further comprise a determination section that measures voltages and currents outputted from the plus-output section and the minus-output section for plural combinations of different on and off states of the plurality of the switches, and determines the combination of on and off states of the plurality of the switches that maximizes the power outputted from the plus-output section and the minus-output section, based on the measurement results of the voltages and currents measured for the plural combinations.

In the foregoing power supply system provided with the switching circuit, the power supply system may further comprise a determination section that measures voltages and currents outputted from the plus-output section and the minus-output section for plural combinations of different on and off states of the plurality of the switches, and determines whether a fault has occurred in the DC power source based on the measurement results of the voltages and currents measured for the plural combinations.

In the foregoing power supply system provided with the switching circuit, all of the switches of the switching circuit may be controlled by a switching control.

A switching circuit according to yet another aspect of the present invention comprises a plurality of input sections to which a plurality of DC power sources are connected, and a plurality of output sections that output DC powers to a plurality of power-supply targets, and switches connection states between the plurality of the input sections and the plurality of the output sections.

In the foregoing switching circuit, the switching circuit may comprise a plurality of plus-input sections to which plus-output terminals of the plurality of the DC power sources are connected, a plurality of minus-input sections to which minus-output terminals of the plurality of the DC power sources are connected, a plurality of plus-output sections, a plurality of minus-output sections, and a connection circuit section provided between the plurality of the plus-input sections and the plurality of the minus-input sections, and the plurality of the plus-output sections and the plurality of the minus-output sections, and has a plurality of switches capable of respectively controlling a turn on/off so as to switch connection states between the plurality of the DC power sources and the plurality of the plus-output sections and the plurality of the minus-output sections.

In the foregoing switching circuit, the connection circuit section may include a plurality of first connection lines that are individually connected to the plus-output terminals of the plurality of the DC power sources, a plurality of second connection lines that are individually connected to the minus-output terminals of the plurality of the DC power sources, a plurality of first switches capable of respectively controlling a turn on/off that are individually disposed between the plurality of the first connection lines and the plurality of the plus-output sections, a plurality of second switches capable of respectively controlling a turn on/off that are individually disposed between the plurality of the second connection lines and the plurality of the minus-output sections, and a plurality of third switches capable of respectively controlling a turn on/off which are disposed between the first connection lines and the second connection lines of combinations in which the DC power sources are different from each other among plural combinations of the plurality of the first connection lines and the plurality of the second connection lines.

In the foregoing switching circuit may be a multi-layer switching circuit configured with multiple layers of circuits.

Furthermore, part or all of the program used for the control may be a trained model created by machine learning.

### Advantageous Effects of Invention

According to the present invention, by combining an environmental power generation, which generates an electrical power by harvesting an energy from an environment, with a wireless power transfer, it is possible to increase a power supplied from a whole of the system to a target apparatus.

### BRIEF DESCRIPTION OF DRAWINGS

FIG. 1 is a block diagram showing an example of a configuration of a power supply system according to an embodiment.

FIG. 2 is an illustration showing an example of a schematic configuration of a wireless transmission system including a power-reception apparatus connected to the power supply system according to the embodiment.

FIG. 3 is a block diagram showing an example of a configuration of the power-reception apparatus according to the embodiment.

FIG. 4 is a block diagram showing another example of the configuration of the power supply system according to the embodiment.

FIG. 5 is a block diagram showing yet another example of the configuration of the power supply system according to the embodiment.

FIG. 6 is a circuit diagram showing an example of a configuration of a switching circuit applicable to the power supply system according to the embodiment.

FIG. 7 is a circuit diagram showing another example of the configuration of the switching circuit applicable to the power supply system according to the embodiment.

FIG. 8 is a circuit diagram showing yet another example of the configuration of the switching circuit applicable to the power supply system according to the embodiment.

### DESCRIPTION OF EMBODIMENTS

Hereinafter, embodiments of the present invention are described with reference to the drawings.

A system according to an embodiment described in the present specification is a power supply system that functions as an apparatus of multi-input and multi-output of electric power, which is capable of inputting DC powers from a plurality of DC power sources including a power-reception apparatus of wireless power transfer (WPT) and an environmental-power-generation apparatus, and outputting DC powers to a plurality of supply targets via a switching circuit. The power supply system according to the present embodiment can supply a power generated by the environmental-power-generation apparatus (also called “energy harvesting apparatus”) to a plurality of power-supply targets, and can increase the power supplied to each power-supply target by combining with the power-reception apparatus of wireless power transfer (WPT). In particular, the power supply system according to the present embodiment is suitable for use as a power-reception system for IoT capable of supplying a power to a huge number of IoT apparatuses that are expected to be installed in various locations. Furthermore, the power supply system according to the present embodiment is provided with a switching circuit for multiple-connection, which has a plurality of switches capable of respectively controlling a turn on/off, thereby enabling a flexible connection configuration of a plurality of DC power sources so as to increase an output power.

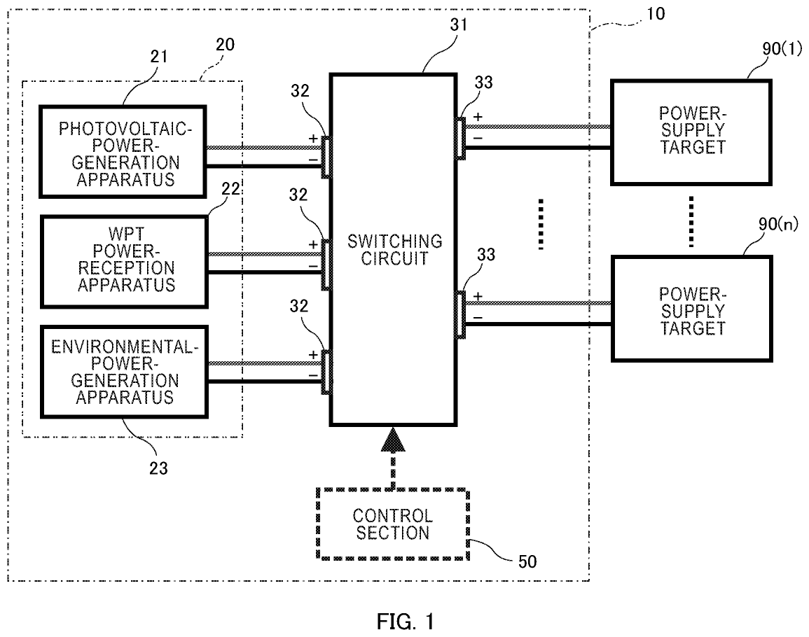

FIG. 1 is a block diagram showing an example of a configuration of a power supply system 10 according to the present embodiment. The power supply system 10 of the present embodiment is provided with a plurality of DC power sources 20 and a switching circuit 31. The plurality of the DC power sources 20 include one or plural power-reception apparatuses (hereinafter also referred to as “WPT power-reception apparatuses”) 22 of wireless power transfer (WPT), and one or plural environmental-power-generation apparatuses 23. The plurality of the DC power sources 20 may include one or plural photovoltaic-power-generation apparatuses (for example, power generation apparatuses of a solar-power generation system) 21, as in the illustrated configuration example.

The plurality of the WPT power-reception apparatuses 22 may respectively receive beams using radio waves of frequency bands different from each other (for example, millimeter waves or microwaves) and respectively output a DC power. For example, the plurality of the WPT power-reception apparatuses 22 may include a first WPT power-reception apparatus that receives a millimeter-wave beam and outputs a DC power, and a second WPT power-reception apparatus that receives a microwave beam and outputs a DC power.

The environmental-power-generation apparatus 23 is, for example, at least one of a thermal-power generation apparatus, a vibration-power generation apparatus, and a radio-wave power generation apparatus. The thermal-power generation apparatus is, for example, a power generation apparatus that can convert various weak thermal energies generated in a surrounding environment into electric power and output the electric power. The vibration-power energy generation apparatus is, for example, a power generation apparatus that can convert weak energies of various vibrations generated in the surrounding environment into electric power and output the electric power. The radio-wave power generation apparatus is, for example, a power generation apparatus that can convert weak energies of radio waves such as various communications and broadcasts generated in the surrounding environment into electric power and output the electric power.

The switching circuit 31 is provided with a plurality of input sections 32 to which the plurality of the DC power sources 20 are connected, and a plurality of output sections 33 that respectively output DC powers to plural (N) power-supply targets 90(1) to 90(n), and switches a connection state between the plurality of the input sections 32 and the plurality of the output sections 33.

The power-supply targets 90(1) to 90(n) are not limited to specific apparatuses. For example, the power-supply targets 90(1) to 90(n) are terminal apparatuses (for example, user apparatuses, IoT devices, etc.) that have communication functions of a mobile communication system, and IoT devices such as sensors that do not have communication functions of the mobile communication system.

According to the power supply system 10 in FIG. 1, the power generated by the environmental-power-generation apparatus (for example, thermal-power generation apparatus, vibration-power generation apparatus, and radio-wave power generation apparatus) 23 can be supplied to the plurality of the power-supply targets 90(1) to 90(n), and the power supplied to each of the plurality of the power-supply targets 90(1) to 90(n) can be increased by combining with the DC power received by the WPT power-reception apparatus and supplying the powers.

It is noted that, the connection state between the plurality of the input sections 32 and the plurality of the output sections 33 in the switching circuit 31 may be set to an uncontrollable fixed connection after connecting the plurality of the DC power sources 20 to the switching circuit 31 and performing initial settings, or may be made controllable by a control section. For example, in the configuration example of FIG. 1, the power supply system 10 may be provided with a control section (first control section) 50 that controls a switching of the connection states between the plurality of the input sections 32 and the plurality of the output sections 33 in the switching circuit 31. By actively controlling the switching circuit 31 with the control section 50, it is possible to improve the power supply efficiency of the multi-input and multi-output in a whole of the power supply system. The control section 50 can perform the control based on pre-installed control information. In addition, the control section 50 may receive control information from an external apparatus such as a server, a management apparatus or a center apparatus, etc., and control the switching of the connection states between the plurality of the input sections 32 and the plurality of the output sections 33 in the switching circuit 31, based on the control information.

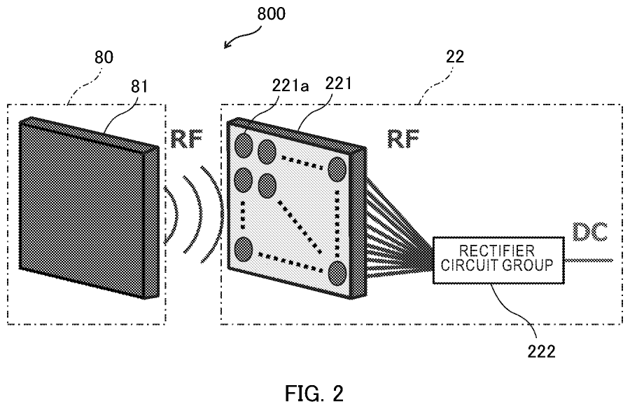

FIG. 2 is an illustration showing an example of a schematic configuration of a wireless-power transfer system 800 including the WPT power-reception apparatus 22 connected to the power supply system 10 according to the present embodiment. The wireless-power transfer system 800 is provided with a power-transmission apparatus 80 that transmits radio waves of a power transmission signal, and the WPT power-reception apparatus (DC power source) 22 that receives the radio waves transmitted from the power-transmission apparatus 80 and outputs a DC power. The radio waves for wireless power transfer are, for example, microwaves or millimeter waves.

The power-transmission apparatus 80 has an antenna apparatus 81 consisting of an array antenna in which a plurality of antenna elements (hereinafter also referred to as “antennas”) are disposed two-dimensionally. The array antenna of the power-transmission apparatus 80 may be an antenna in which a plurality of antennas are disposed one-dimensionally or three-dimensionally.

The WPT power-reception apparatus 22 has an antenna apparatus 221 consisting of an array antenna in which a plurality of antennas 221a are disposed two-dimensionally. The array antenna of the WPT power-reception apparatus 22 may be an antenna in which a plurality of antennas 221a are disposed one-dimensionally or three-dimensionally. The WPT power-reception apparatus 22 also has a rectifier circuit group 222 consisting of plural rectifier circuits (DC power sources) that are provided to correspond to the plurality of the antennas 221a of the antenna apparatus 221. One set of a combination of the antenna 221a and the rectifier circuit is also called a rectenna.

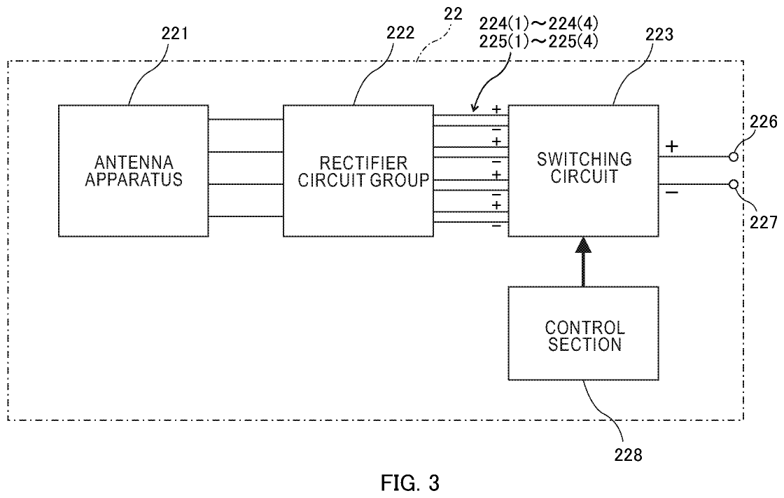

FIG. 3 is a block diagram showing an example of a configuration of the WPT power-reception apparatus 22 according to the present embodiment. It is noted that, although FIG. 3 shows the case where each of the number of antennas and the number of rectifier circuits of the antenna apparatus 221 are 4 (=2×2), the number is not limited to this number. For example, each of the number of antennas and the number of rectifier circuits in the WPT power-reception apparatus 22 may be 9 (=3×3), 16 (=4×4) or 25 (=5×5), etc.

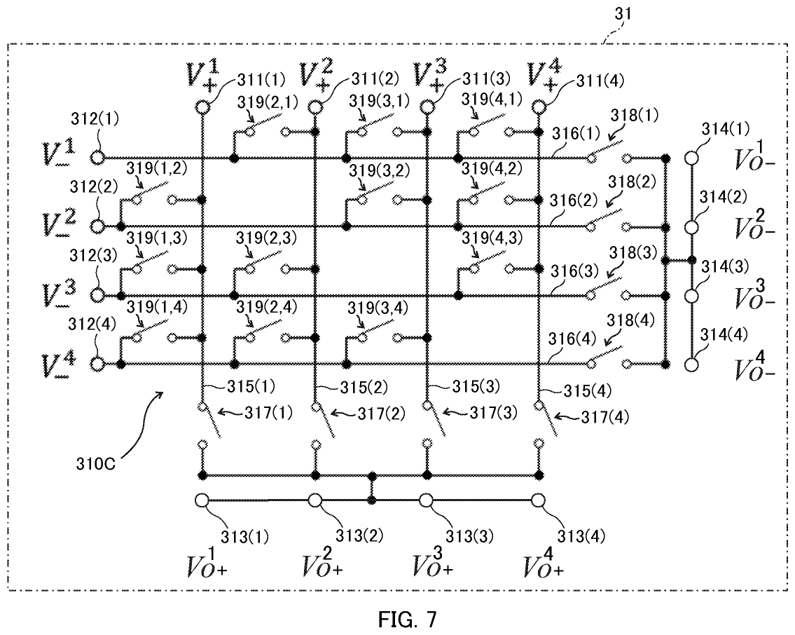

In FIG. 3, a switching circuit 223 is provided in the subsequent stage of the rectifier circuit group 222 that receives an input power from the antenna apparatus 221. As the switching circuit 223, for example, a switching circuit having a configuration similar to that shown in FIG. 7 described later can be used. The switching circuit 223 has a plurality of plus-input sections 224(1) to 224(4) to which the plus-output terminals of the rectifier circuits serving as a plurality of DC rectifier circuits are connected, a plurality of minus-input sections 225(1) to 225(4) to which the minus-output terminals of the plurality of the rectifier circuits are connected, a plus-output section 226, and a minus-output section 227. Furthermore, the switching circuit 223 has connection circuit sections provided between the plurality of the plus-input sections 224(1) to 224(4) and the plurality of the minus-input sections 225(1) to 225(4), and the plus-output section 226 and the minus-output section 227. The connection circuit sections have a plurality of switches capable of respectively controlling a turn on/off so as to switch the connection states between the plurality of the rectifier circuits, and the plus-output section 226 and the minus-output section 227. The plurality of the switches provided in the connection circuit sections of the switching circuit 223 are on/off controlled (actively controlled) by the control section 228. The active control by the control section 228 can improve the power-reception efficiency in the whole of the WPT power-reception apparatus 22.

According to the WPT power-reception apparatus 22 provided with the switching circuit 223 shown in FIG. 3, it is possible to control a switching between a series connection and a parallel connection of the plurality of the rectifier circuits in the rectifier circuit group 222.

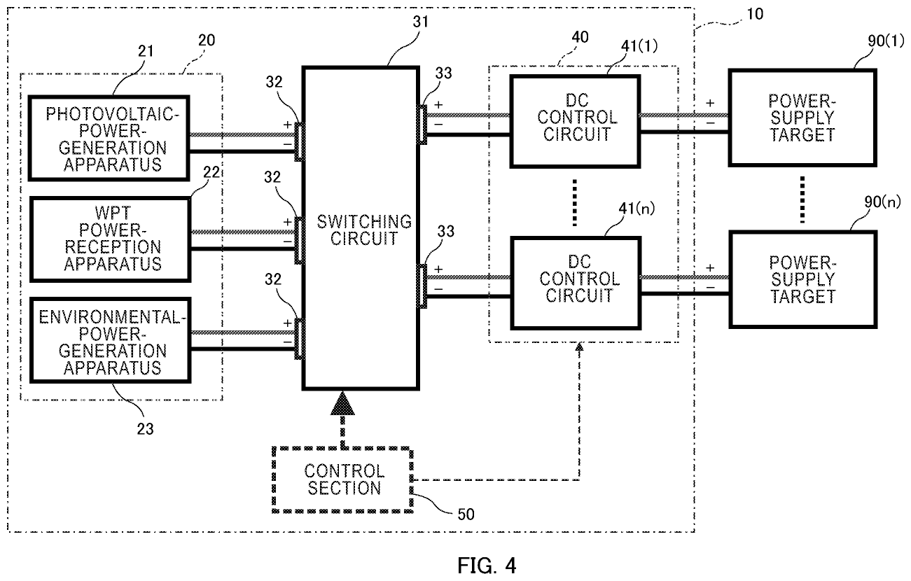

FIG. 4 is a block diagram showing another example of the configuration of the power supply system 10 according to the present embodiment. It is noted that, in FIG. 4, the parts common to those in FIGS. 1 to 3 described above are denoted by the same reference numerals and the descriptions thereof are omitted.

In the configuration example of FIG. 4, a plurality (N) of DC control circuits 41(1) to 41(n) connected to the plurality of the output sections 33 of the switching circuit 31 are provided in the subsequent stage of the switching circuit 31. The DC power is supplied to the plurality of the power-supply targets 90(1) to 90(n) via the DC control circuits 41(1) to 41(n). Each of the plurality of the DC control circuits 41(1) to 41(n) has, for example, at least one circuit of an MPPT (Maximum Power Point Tracking) control circuit, a DC-DC conversion circuit and a rectification circuit.

Furthermore, in FIG. 4, the power supply system 10 may be provided with a second control section that controls a circuit group 40 including the plurality of the DC control circuits 41(1) to 41(n). The second control section may receive control information from an external apparatus such as a server, a management apparatus or a center apparatus, etc., and control the circuit group 40 including the plurality of the DC control circuits 41(1) to 41(n) based on the control information. By actively controlling the circuit group 40 including the plurality of the DC control circuits 41(1) to 41(n) using the control section 50 that also functions as the second control section, it is possible to improve the power supply efficiency of the multi-input and multi-output in the whole of the power supply system. It is noted that, in the configuration example of FIG. 4, although the control section (first control section) 50 that controls the switching circuit 31 is also used as the second control section as shown by the dashed line, the second control section may be provided separately from the control section (first control section) 50.

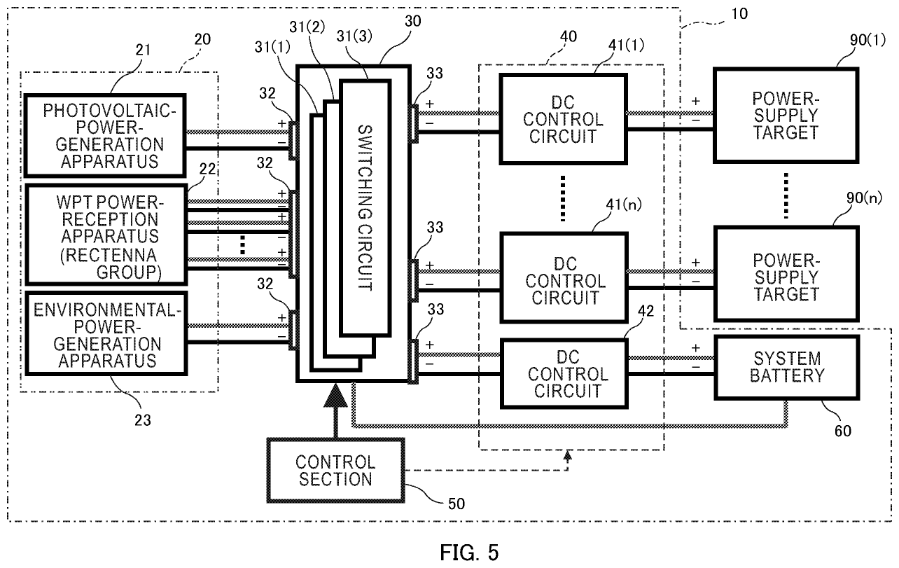

FIG. 5 is a block diagram showing yet another example of the configuration of the power supply system 10 according to the present embodiment. It is noted that, in FIG. 5, the parts common to those in FIGS. 1 to 4 described above are denoted by the same reference numerals and the descriptions thereof are omitted. In the configuration example of FIG. 5, a plurality of DC powers outputted from a plurality of rectifier circuits (rectennas) in the rectifier circuit group 222 of the WPT power-reception apparatus 22 are inputted to the multilayer switching circuit 30.

The multilayer switching circuit 30 is made up of multiple layers of switching circuits 31(1) to 31(3). The multilayer switching circuit 30 is suitable for the case where there are many inputs from the DC power sources, such as the case that the plurality of the DC powers are inputted, which are outputted from the plurality of the rectifier circuits (rectennas) of the WPT power-reception apparatus 22. By using the multilayer switching circuit 30, the size of the entire circuit can be reduced by three-dimensionally connecting the plurality of the switching circuits 31(1) to 31(3), and the switching of the connection states between the plurality of the input sections 32 and the plurality of the output sections 33 can be performed in plural sections by the plurality of the switching circuits 31(1) to 31(3).

For example, the connection states may be switched in plural sections using the plurality of the switching circuits 31(1) to 31(3) as follows. The first switching circuit 31(1) switches the connection states between the output sections and the plurality of the input sections to which the plurality of the DC powers are inputted, which are outputted from the plurality of the rectifier circuits (rectennas) of the WPT power-reception apparatus 22. In addition, the second switching circuit 31(2) switches the connection states between the output sections and the plurality of the input sections to which the plurality of the DC powers are inputted, which are outputted from the plurality of the environmental-power-generation apparatuses 23. Then, the third switching circuit 31(3) switches the connection states between the plurality of the input sections to which the DC voltages are inputted, and the plurality of the output sections 33 corresponding to the plurality of the power-supply targets 90(1) to 90(n). The foregoing DC voltages are the DC voltage from the output section of the first switching circuit 31(1), the DC voltage from the output section of the second switching circuit 31(2) and the DC power from the photovoltaic-power-generation apparatus 21.

Furthermore, the configuration example of FIG. 5 is provided with a system battery 60 as a power source for supplying a power to operate active elements such as switching elements that make up the multilayer switching circuit 30. The system battery 60 may be used as a source power supply for other control circuits, such as a DC control circuit, other than the multilayer switching circuit 30. The multilayer switching circuit 30 is provided with an output section for the system battery 60 in addition to the plurality of the output sections 33 corresponding to the plurality of the power-supply targets 90(1) to 90(n). The system battery 60 can be charged with a power supplied from the output section 33 provided separately in the multilayer switching circuit 30, via the DC control circuit 42.

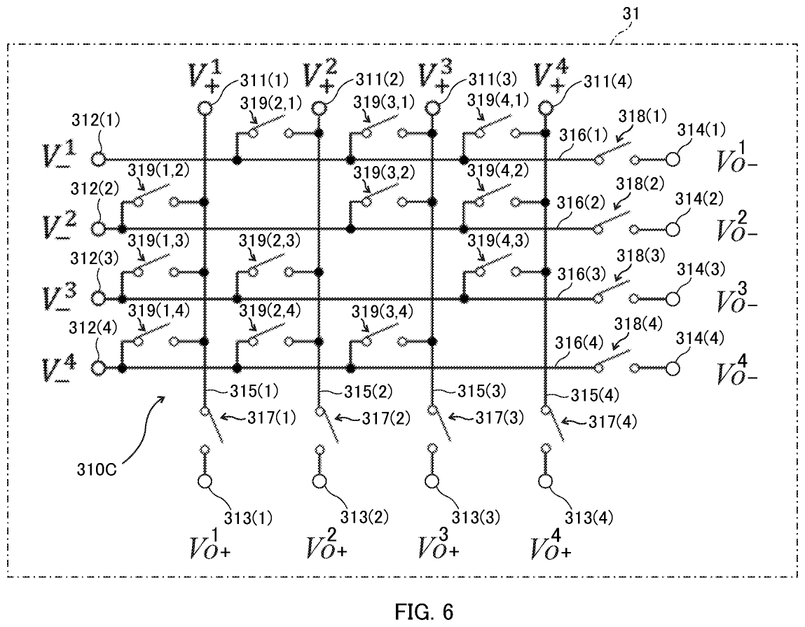

FIG. 6 is a circuit diagram showing an example of a configuration of a switching circuit 31 that can be applied to the power supply system 10 according to the present embodiment. In FIG. 6, the connection circuit section 310C of the switching circuit 31 has a plurality of first connection lines 315(1) to 315(4) that are individually connected to plus-output terminals 311(1) to 311(4) to which plus voltages V+¹ to V+⁴ of the plurality of the DC power sources 20 are inputted, and a plurality of second connection lines 316(1) to 316(4) that are individually connected to minus-output terminals 312(1) to 312(4) to which minus voltages V−¹ to V−⁴ of the plurality of the DC power sources 20 are inputted.

Furthermore, the connection circuit section 310C has a plurality of first switches 317(1) to 317(4), a plurality of second switches 318(1) to 318(4), and a plurality of third switches 319(1,2), 319(1,3), 319(1,4), 319(2,1), 319(2,3), 319(2,4), 319(3,1), 319(3,2), 319(3,4), 319(4, 1), 319(4,2) and 319(4,2).

Each of the first switches 317(1) to 317(4) is a switch capable of respectively controlling a turn on/off, which is individually disposed between the first connection lines 315(1) to 315(4) and the plus-output sections 313(1) to 313(4). Each of the second switches 318(1) to 318(4) is a switch capable of respectively controlling a turn on/off, which is individually disposed between the second connection lines 316(1) to 316(4) and the minus-output sections 314(1) to 314(4). Plus voltages Vₒ₊¹ to Vₒ₊⁴ are outputted from the plus-output sections 313(1) to 313(4) toward the plurality of the power-supply targets 90(1) to 90(4). Furthermore, minus voltages Vₒ₋¹ to Vₒ₋⁴ are outputted from the minus-output sections 314(1) to 314(4) toward the plurality of the power-supply targets 90(1) to 90(4).

Each of the plurality of the third switches is a switch capable of respectively controlling a turn on/off, which is disposed between the first connection lines and the second connection lines of combinations in which the DC power sources are different from each other, among plural combinations of the first connection lines 315(1) to 315(4) and the second connection lines 316(1) to 316(4). For example, each of the third switches 319(1,2), 319(1,3) and 319(1,4) is disposed between the first connection line 315(1) and the second connection lines 316(2), 316(3) and 316(4). Each of the third switches 319(2, 1), 319(2,3) and 319(2,4) is disposed between the first connection line 315(2) and the second connection lines 316(1), 316(3) and 316(4). Each of the third switches 319(3,1), 319(3,2) and 319(3,4) is disposed between the first connection line 315(3) and the second connection lines 316(1), 316(2), and 316(4). Each of the third switches 319(4, 1), 319(4,2) and 319(4,2) is disposed between the first connection line 315(4) and the second connection lines 316(1), 316(2) and 316(3).

By controlling the on/off of each switch of the switching circuit 310 configured as described above by the control section 50, it is possible to appropriately switch between a series connection and a parallel connection for some or all of the plurality of the DC power sources 20. In particular, by controlling the switching of all of the first switch, the second switch and the third switch of the switching circuit 310 configured as described above, it is possible to reproduce any connections of the plurality of the DC power sources 20.

Herein, when the number of each of the aforementioned plurality of DC power sources 20, the plurality of the first connection lines, the plurality of the second connection lines, the plurality of the first switches and the plurality of the second switches is N, the number of the plurality of the third switches is N²−N, the total number of switches is N²+N, and the on state is represented as 1 and the off state is represented as 0, the control section 50 may control the on/off of the aforementioned plurality of first switches, the plurality of the second switches and the plurality of the third switches, based on the following matrix of (N+1) rows by (N+1) columns.

$$[ \begin{matrix}0 & 1 or 0 & … & 1 or 0 \\ 1 or 0 & ⋱ & ⋱ & ⋮ \\ ⋮ & ⋱ & ⋱ & 1 or 0 \\ 1 or 0 & … & 1 or 0 & 0\end{matrix} ] \qquad [ Mathematical 2 ]$$

FIG. 7 is a circuit diagram showing another example of the configuration of the switching circuit 31 that can be applied to the power supply system 10 according to the embodiment. It is noted that, in FIG. 7, the parts common to those in FIG. 6 described above are denoted by the same reference numerals and the descriptions thereof are omitted.

In the switching circuit 31 of FIG. 7, the output sides of the first switches 317(1) to 317(4) are connected in parallel to generate a combined DC voltage, which is outputted as plus voltages Vₒ₊¹ to Vₒ₊⁴ from the plus-output sections 313(1) to 313(4) to the plurality of the power-supply targets 90(1) to 90(4). Furthermore, the output sides of the second switches 318(1) to 318(4) are connected in parallel to synthesize a DC voltage, which is outputted as minus voltages Vₒ₋¹ to Vₒ₋⁴ from minus-output sections 314(1) to 314(4) to the plurality of the power-supply targets 90(1) to 90(4).

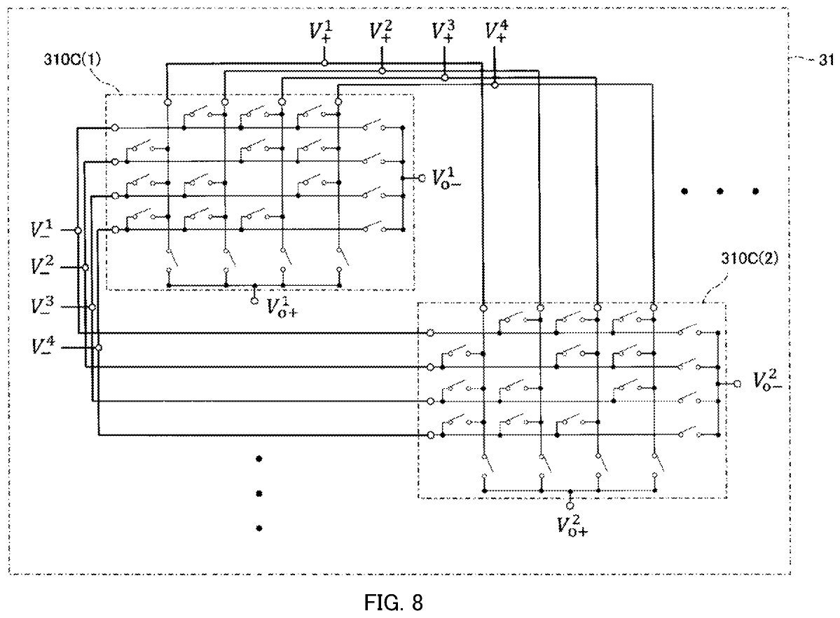

FIG. 8 is a circuit diagram showing yet another example of the configuration of the switching circuit 31 applicable to the power supply system 10 according to the embodiment. In FIG. 8, the parts common to those in FIGS. 6 and 7 described above are denoted by the same reference numerals and the descriptions thereof are omitted.

The switching circuit 31 in FIG. 7 is provided with plural sets (for example, four sets) of connection circuit sections 310C(1), 310C(2), Each of the connection circuit sections 310C(1), 310C(2), . . . has a circuit configuration similar to that of the connection circuit section 310C in FIGS. 6 and 7. The switching circuit 31 may be a three-dimensionally connected multiplexed circuit in which plural sets of connection circuit sections 310C(1), 310C(2), . . . are configured in a layered configuration.

The plus voltages V₊¹ to V₊⁴ and the minus voltages V₋¹ to V₋⁴ of the plurality of the DC power sources 20 are inputted to each of the plural sets of connection circuit sections 310C(1), 310C(2), Furthermore, the plural sets of connection circuit sections 310C(1), 310C(2), . . . output plus voltages Vₒ₊¹, Vₒ₊², . . . and minus voltages Vₒ₋¹, Vₒ₋², For example, the connection circuit section 310C(1) outputs the plus voltage Vₒ₊¹ and the minus voltage Vₒ₋¹.

As described above, according to the present embodiment, by combining the environmental-power-generation apparatus 23 (for example, thermal-power generation apparatus, vibration-power generation apparatus or radio-wave power generation apparatus) with the WPT power-reception apparatus 22, it is possible to increase the power supplied from the whole of the system to the plurality of the power-supply targets 90(1) to 90(n).

In particular, according to the present embodiment, it is possible to supply the power to a huge number of IoT devices that are expected to be installed in various locations.

Furthermore, according to the present embodiment, by the switching circuit 31 for multiple connections having the plurality of the switches capable of respectively controlling a turn on/off, a flexible connection configuration of the plurality of the DC power sources is possible to increase the output power.

Moreover, according to the present embodiment, by controlling the switching of all of the plurality of the first switches, the plurality of the second switches and the plurality of the third switches in the switching circuit 31 described above, it is possible to reproduce any connections of the plurality of the DC power sources (rectifier circuits, power supply circuits).

In addition, since the present invention can provide a power supply system that can supply the power generated by the environmental-power-generation apparatus to the plurality of the power-supply targets and can increase the power supplied to each power-supply target by combining it with the wireless power transfer, it is possible to contribute to achieving Goal 9 of the Sustainable Development Goals (SDGs), which is to “Create a foundation for industry and technological innovation”.

It is noted that, the process steps and configuration elements of the system described in the present description can be implemented with various means. For example, these process steps and configuration elements may be implemented with hardware, firmware, software, or a combination thereof.

With respect to hardware implementation, means such as processing units or the like used for establishing the foregoing steps and configuration elements in entities (for example, switching circuit, DC power-source-output apparatus, power-reception apparatus, power-transmission apparatus, power-generation apparatus, rectifier circuit, power supply circuit, various kinds of radio communication apparatuses, base station apparatus (Node B, Node G), terminal apparatus, hard disk drive apparatus, or optical disk drive apparatus) may be implemented in one or more of an application-specific IC (ASIC), a digital signal processor (DSP), a digital signal processing apparatus (DSPD), a programmable logic device (PLD), a field programmable gate array (FPGA), a processor, a controller, a microcontroller, a microprocessor, an electronic device, other electronic unit, computer, or a combination thereof, which are designed so as to perform a function described in the present specification.

With respect to the firmware and/or software implementation, means such as processing units or the like for using to establish the foregoing configuration elements may be implemented with a program (for example, code such as procedure, function, module, instruction, etc.) for performing a function described in the present specification. In general, any computer/processor readable medium of materializing the code of firmware and/or software may be used for implementation of means such as processing units and so on for establishing the foregoing steps and configuration elements described in the present specification. For example, in a control apparatus, the firmware and/or software code may be stored in a memory and executed by a computer or processor. The memory may be implemented within the computer or processor, or outside the processor. Further, the firmware and/or software code may be stored in, for example, a medium capable being read by a computer or processor, such as a random-access memory (RAM), a read-only memory (ROM), a non-volatility random-access memory (NVRAM), a programmable read-only memory (PROM), an electrically erasable PROM (EEPROM), a FLASH memory, a floppy (registered trademark) disk, a compact disk (CD), a digital versatile disk (DVD), a magnetic or optical data storage unit, or the like. The code may be executed by one or more of computers and processors, and a certain aspect of functionalities described in the present specification may by executed by a computer or processor.

The medium may be a non-transitory recording medium. Further, the code of the program may be executable by being read by a computer, a processor, or another device or an apparatus machine, and the format is not limited to a specific format. For example, the code of the program may be any of a source code, an object code, and a binary code, and may be a mixture of two or more of those codes.

The description of embodiments disclosed in the present specification is provided so that the present disclosures can be produced or used by those skilled in the art. Various modifications of the present disclosures are readily apparent to those skilled in the art and general principles defined in the present specification can be applied to other variations without departing from the spirit and scope of the present disclosures. Therefore, the present disclosures should not be limited to examples and designs described in the present specification and should be recognized to be in the broadest scope corresponding to principles and novel features disclosed in the present specification.

### REFERENCE SIGNS LIST

10: power supply system
20: DC power source
21: photovoltaic-power-generation apparatus
22: WPT power-reception apparatus
23: environmental-power-generation apparatus
30: multilayer switching circuit
31: switching circuit
32: input section
33: output section
40: circuit group
41: DC control circuit
42: DC control circuit
50: control section
60: system battery
80: power-transmission apparatus
81: antenna apparatus
90: power-supply target
800: wireless-power transfer system

1. A power supply system, comprising:
a plurality of DC power sources including an environmental-power-generation apparatus and a power-reception apparatus capable of receiving a beam for wireless power transfer and outputting a DC power;
a switching circuit that has a plurality of input sections to which the plurality of the DC power sources are connected and a plurality of output sections that output DC powers to a plurality of power-supply targets, and that switches connection states between the plurality of the input sections and the plurality of the output sections; and
a system battery for supplying a DC power to the switching circuit, the plurality of the output circuits, or both, and
wherein the plurality of the output sections of the switching circuit include an output section for outputting a DC current to the system battery.

2. The power supply system according to claim 1,
wherein the plurality of the DC power sources include one or plural power-reception apparatuses for wireless power transfer, one or plural photovoltaic-power-generation apparatuses, and one or plural environmental-power-generation apparatuses.

3. The power supply system according to claim 1,
wherein the environmental-power-generation apparatus is at least one of a thermal-power generation apparatus, a vibration-power generation apparatus and a radio-wave power generation apparatus.

4. The power supply system according to claim 1, comprising a first control section for controlling a switching of connection states between the plurality of the input sections and the plurality of the output sections in the switching circuit.

5. The power supply system according to claim 1, comprising a plurality of DC control circuits that are connected to the plurality of the output sections of the switching circuit.

6. The power supply system according to claim 5,
wherein the DC control circuit has at least one circuit of an MPPT (Maximum Power Point Tracking) control circuit, a DC-DC conversion circuit and a rectification circuit.

7. The power supply system according to claim 5, comprising a second control section for controlling the DC control circuit.

8. (canceled)

9. A switching circuit, comprising:
a plurality of input sections to which a plurality of DC power sources are connected; and
a plurality of output sections that output DC powers to a plurality of power-supply targets, and
wherein the plurality of the output sections include an output section for outputting a DC current to a system battery for supplying a DC power to the switching circuit, the plurality of the output circuits, or both, and
wherein the switching circuit switches connection states between the plurality of the input sections and the plurality of the output sections.

10. The switching circuit according to claim 9,
wherein the switching circuit comprises:
a plurality of plus-input sections to which plus-output terminals of the plurality of the DC power sources are connected;
a plurality of minus-input sections to which minus-output terminals of the plurality of the DC power sources are connected;
a plurality of plus-output sections;
a plurality of minus-output sections; and
a connection circuit section provided between the plurality of the plus-input sections and the plurality of the minus-input sections, and the plurality of the plus-output sections and the plurality of the minus-output sections, and has a plurality of switches capable of respectively controlling a turn on/off so as to switch the connection states between the plurality of the DC power sources and the plurality of the plus-output sections and the plurality of the minus-output sections.

11. The switching circuit according to claim 10,
wherein the connection circuit section includes:
a plurality of first connection lines that are individually connected to the plus-output terminals of the plurality of the DC power sources;
a plurality of second connection lines that are individually connected to the minus-output terminals of the plurality of the DC power sources;
a plurality of first switches capable of respectively controlling a turn on/off that are individually disposed between the plurality of the first connection lines and the plurality of the plus-output sections;
a plurality of second switches capable of respectively controlling a turn on/off that are individually disposed between the plurality of the second connection lines and the plurality of the minus-output sections; and
a plurality of third switches capable of respectively controlling a turn on/off, the third switches being disposed between the first connection lines and the second connection lines of combinations in which the DC power sources are different from each other, among plural combinations of the plurality of the first connection lines and the plurality of the second connection lines.

12. The switching circuit according to claim 9,
wherein the switching circuit is configured with multiple layers of circuits.

13. A power supply system, comprising:
a plurality of DC power sources including plural environmental-power-generation apparatuses, one or plural power-reception apparatuses capable of receiving a beam for wireless power transfer and outputting a DC power, and a photovoltaic-power-generation apparatus; and
a switching circuit that has a plurality of input sections to which the plurality of the DC power sources are connected and a plurality of output sections that output DC powers to a plurality of power-supply targets, and that switches connection states between the plurality of the input sections and the plurality of the output sections, and
wherein the switching circuit is configured with multiple layers of circuits, and
wherein the switching circuit comprises:
a first switching circuit for switching connection states between the output sections and a plurality of input sections to which a plurality of DC powers are inputted, the DC powers being outputted from a plurality of rectifier circuits of the power-reception apparatus;
a second switching circuit for switching connection states between the output sections and a plurality of input sections to which a plurality of DC powers are inputted, the DC powers being outputted from the plural environmental-power-generation apparatuses; and
a third switching circuit for switching connection states between the plurality of the output sections and a plurality of input sections to which DC voltages and a DC power are inputted, the DC voltages being outputted from an output section of the first switching circuit and an output section of the second switching circuit, and the DC power being outputted from the photovoltaic-power-generation apparatus.

14. The power supply system according to claim 13,
wherein the environmental-power-generation apparatus is at least one of a thermal-power generation apparatus, a vibration-power generation apparatus and a radio-wave power generation apparatus.

15. The power supply system according to claim 13, comprising a first control section for controlling a switching of connection states between the plurality of the input sections and the plurality of the output sections in the switching circuit.

16. The power supply system according to claim 13, comprising a plurality of DC control circuits that are connected to the plurality of the output sections of the switching circuit.

17. The power supply system according to claim 13, comprising a system battery for supplying a DC power to the switching circuit, the plurality of the output circuits, or both, and
wherein the plurality of the output sections of the switching circuit include an output section for outputting a DC current to the system battery.

18. A switching circuit, comprising:
a plurality of DC power sources including plural environmental-power-generation apparatuses, one or plural power-reception apparatuses capable of receiving a beam for wireless power transfer and outputting a DC power, and a photovoltaic-power-generation apparatus; and
a switching circuit that has a plurality of input sections to which the plurality of the DC power sources are connected and a plurality of output sections that output DC powers to a plurality of power-supply targets, and that switches connection states between the plurality of the input sections and the plurality of the output sections, and
wherein the switching circuit is configured with multiple layers of circuits, and
wherein the switching circuit comprises:
a first switching circuit for switching connection states between the output sections and a plurality of input sections to which a plurality of DC powers are inputted, the DC powers being outputted from a plurality of rectifier circuits of the power-reception apparatus;
a second switching circuit for switching connection states between the output sections and a plurality of input sections to which a plurality of DC powers are inputted, the DC powers being outputted from the plural environmental-power-generation apparatuses; and
a third switching circuit for switching connection states between the plurality of the output sections and a plurality of input sections to which DC voltages and a DC power are inputted, the DC voltages being outputted from an output section of the first switching circuit and an output section of the second switching circuit, and the DC power being outputted from the photovoltaic-power-generation apparatus.

19. The switching circuit according to claim 18,
wherein the switching circuit comprises:
a plurality of plus-input sections to which plus-output terminals of the plurality of the DC power sources are connected;
a plurality of minus-input sections to which minus-output terminals of the plurality of the DC power sources are connected;
a plurality of plus-output sections;
a plurality of minus-output sections; and
a connection circuit section provided between the plurality of the plus-input sections and the plurality of the minus-input sections, and the plurality of the plus-output sections and the plurality of the minus-output sections, and has a plurality of switches capable of respectively controlling a turn on/off so as to switch the connection states between the plurality of the DC power sources and the plurality of the plus-output sections and the plurality of the minus-output sections.

20. The switching circuit according to claim 19,
wherein the connection circuit section includes:
a plurality of first connection lines that are individually connected to the plus-output terminals of the plurality of the DC power sources;
a plurality of second connection lines that are individually connected to the minus-output terminals of the plurality of the DC power sources;
a plurality of first switches capable of respectively controlling a turn on/off that are individually disposed between the plurality of the first connection lines and the plurality of the plus-output sections;
a plurality of second switches capable of respectively controlling a turn on/off that are individually disposed between the plurality of the second connection lines and the plurality of the minus-output sections; and
a plurality of third switches capable of respectively controlling a turn on/off, the third switches being disposed between the first connection lines and the second connection lines of combinations in which the DC power sources are different from each other, among plural combinations of the plurality of the first connection lines and the plurality of the second connection lines.
